(19) United States
(12) Patent Application Publication
(10) Pub. No.: US 2011/0251778 A1
(43) Pub. Date: Oct. 13, 2011

(54) FUEL INJECTION CONTROL APPARATUS

(75) Inventors: Yoshiharu SAITO, Nagoya (JP); Tsukasa Kaneko, Toyohashi-shi (JP)

(73) Assignee: DENSO CORPORATION, Kariya-city (JP)

(21) Appl. No.: 13/082,504

(22) Filed: Apr. 8, 2011

(30) Foreign Application Priority Data
Apr. 9, 2010 (JP) 2010-090788

(51) Int. Cl. F02D 28/00

(52) U.S. Cl. 701/103

(57) ABSTRACT

A fuel injection control apparatus, which is applied to a cylinder-injection internal combustion engine directly injecting fuel into a cylinder from a fuel injection valve, includes an injection control unit which issues a command to perform injection control for the fuel injection valve by using an injection command signal, a drive circuit which drives the fuel injection valve based on the injection command signal outputted from the injection control unit, and a temperature information obtaining unit which obtains temperature information associated with temperature in the fuel injection control apparatus. The injection control unit issues a command to perform injection control for reducing heat generation of the drive circuit by using the injection command signal based on the temperature information obtained by the temperature information obtaining unit.

### CROSS-REFERENCE TO RELATED APPLICATION

This application is based on and claims the benefit of priority from earlier Japanese Patent Application No. 2010-090788 filed Apr. 9, 2010, the description of which is incorporated herein by reference.

### BACKGROUND

1. Technical Field

The present invention relates to a fuel injection control apparatus applied to a cylinder-injection internal combustion engine.

2. Related Art

In a known fuel injection control apparatus, fuel injection is controlled by supplying drive current to fuel injection valves from a drive circuit disposed in the apparatus. In this case, the drive circuit may generate heat to excessively raise the temperature inside the fuel injection control apparatus. In particular, in a cylinder-injection internal combustion engine, the pressure of the fuel supplied to the fuel injection valves is high compared to a port-injection internal combustion engine. This may raise the heat generation rate of the drive circuit and thus may lead to easy temperature rise inside the fuel injection control apparatus.

Such an excessive increase of temperature in the fuel injection control apparatus is likely to cause malfunction or failure not only in the microcomputer but also in other electronic parts installed in the apparatus.

In this regard, JP-B-4319710 discloses a technique for cooling an electronic control apparatus. Specifically, in this technique, the temperature inside an electronic control apparatus is sensed by a temperature sensing element. When the temperature in the apparatus becomes equal to or more than a predetermined temperature, a blowing fan is actuated to supply cooling air to the electronic control apparatus from an air conditioner, so that the apparatus is cooled.

However, such a configuration for cooling an electronic control apparatus from outside using cooling air or the like is not able to sufficiently cool the inside of each electronic part, such as a microcomputer, and thus is likely to cause malfunction or failure due to the temperature rise. This configuration raises another issue of requiring additional mechanism for cooling the electronic control apparatus.

### SUMMARY

An embodiment provides a fuel injection control apparatus which suppresses temperature rise in the apparatus caused by the driving of fuel injection valves, without requiring additional installation of a cooling mechanism.

An embodiment provides a fuel injection control apparatus, which is applied to a cylinder-injection internal combustion engine directly injecting fuel into a cylinder from a fuel injection valve, including: an injection control unit which issues a command to perform injection control for the fuel injection valve by using an injection command signal; a drive circuit which drives the fuel injection valve based on the injection command signal outputted from the injection control unit; and a temperature information obtaining unit which obtains temperature information associated with temperature in the fuel injection control apparatus, wherein the injection control unit issues a command to perform injection control for reducing heat generation of the drive circuit by using the injection command signal based on the temperature information obtained by the temperature information obtaining unit.

### BRIEF DESCRIPTION OF THE DRAWINGS

In the accompanying drawings:

FIG. 1 is a schematic diagram illustrating a fuel injection system according to an embodiment;

FIG. 2A is a time diagram illustrating a drive current in the case where the pulse width of an injection command signal exceeds a predetermined width;

FIG. 2B is a time diagram illustrating a drive current in the case where the pulse width of an injection command signal is equal to or less than the predetermined width;

FIG. 3A is a time diagram illustrating single-stage injection;

FIG. 3B is a time diagram illustrating multi-stage injection;

FIG. 4 is a characteristic diagram illustrating a relationship between thermistor temperature or engine speed and injection control;

FIG. 5 is a characteristic diagram illustrating a relationship between thermistor temperature or engine speed and injection control; and

FIG. 6 is a characteristic diagram illustrating a relationship between thermistor temperature or engine speed and fuel pressure.

### DETAILED DESCRIPTION OF THE PREFERRED EMBODIMENTS

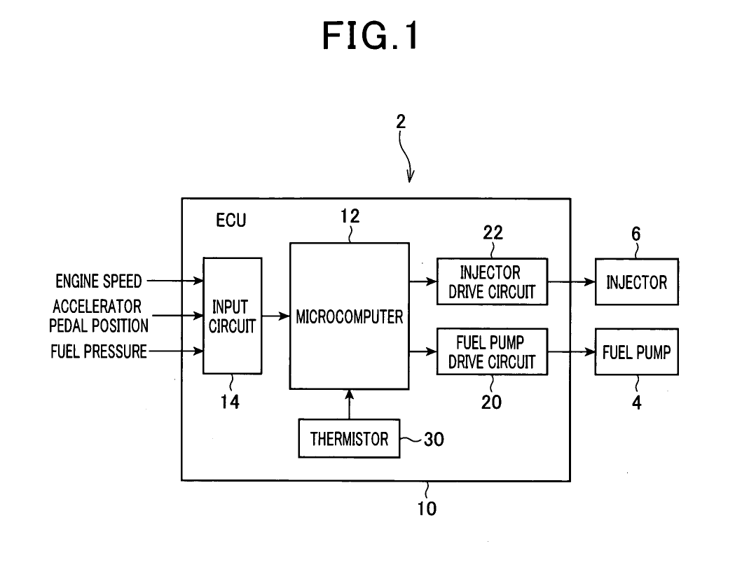

With reference to the accompanying drawings, hereinafter will be described an embodiment. FIG. 1 is a schematic diagram illustrating a fuel injection system 2 according to the present embodiment.

(Fuel Injection System 2)

The fuel injection system 2 is a system that injects fuel such as to a direct-injection gasoline engine. The fuel injection system 2 includes a fuel pump 4, fuel injection valves (also referred to as “injectors”) 6 arranged in respective cylinders, and an electronic control unit (ECU: electronic control unit) 10 that controls the fuel pump 4 and the injectors 6.

The fuel pump 4 pressurizes and discharges fuel taken into a pressurizing chamber, when a plunger is reciprocally driven with the rotation of the cam of a cam shaft. The discharge rate of the fuel pump 4 is regulated by an electromagnetically driven regulating valve that regulates the intake rate of fuel.

Each injector 6 injects fuel when drive current is supplied to its electromagnetic driver and its needle is lifted to open the valve. When the supply of drive current to the electromagnetic driver is cut off, the valve of each injector 6 is closed for the completion of fuel injection.

The ECU 10 includes a microcomputer 12, an input circuit 14, a fuel pump drive circuit 20, an injector drive circuit 22, a thermistor 30 and a memory, not shown.

The microcomputer 12 executes a control program stored in the memory. With the execution of the control program, the ECU 10 controls fuel discharge of the fuel pump 4 and fuel injection of the injectors 6, for example, based on output signals of various sensors reflecting engine speed, accelerator pedal position, fuel pressure, device temperature, and the like.

For example, the ECU 10 regulates the discharge rate of the fuel pump 4 to control the pressure of fuel supplied to each of the injectors 6. Also, the ECU 10 uses a fuel command signal, which is generated based on the engine operating conditions to control the injectors 6 regarding injection start timing, injection quantity, and the number of injections in one combustion cycle. It should be appreciated that one combustion cycle consists of four processes, i.e. intake, compression, expansion and discharge.

The input circuit 14 inputs signals outputted from the various sensors and performs A/D conversion to output the converted signals to the microcomputer 12.

The fuel pump drive circuit 20 controls opening/closing of the regulating valve of the fuel pump 4 based on a control signal outputted from the microcomputer 12, so that the amount of fuel sucked by the fuel pump 4 is regulated. Thus, the discharge rate of the pump 4 is regulated.

The injector drive circuit 22 controls drive current supplied to the electromagnetic driver of each of the injectors 6, based on an injection command signal outputted from the microcomputer 12. The injector drive circuit 22 includes a step-up circuit, not shown, and a transistor used for switching. The step-up circuit is provided with a capacitor for supplying high current in order that each of the injectors 6 is promptly turned to an opened state from a closed state.

Hereinafter is described the amount of heat generated at the injector drive circuit 22 by the driving of the injectors 6.

(Heat Generation Rate)

(1) Pulse Width

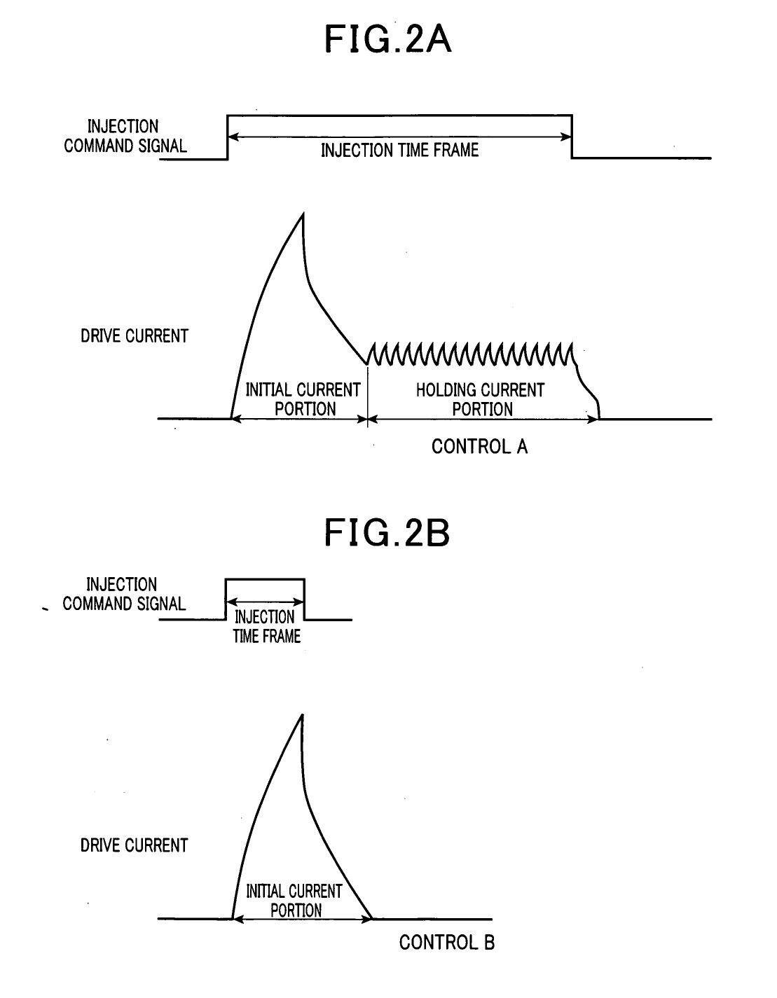

As shown in FIGS. 2A and 2B, the microcomputer 12 outputs pulsed injection command signals. An injection start timing of each of the injectors 6 is determined by the rising edge of a fuel command signal. Meanwhile, an injection quantity of each of the injectors 6 is determined by the pulse width that is the signal width of an injection command signal.

The ECU 10 stores in its memory an injection characteristics map indicating a relationship between the pulse width of the injection command signal and the injection quantity, for each predetermined range of fuel pressure. The microcomputer 12 detects the pressure of fuel supplied to each of the injectors 6, based on an output signal derived from a pressure sensor, not shown. Then, the microcomputer 12 refers to the fuel characteristics map. Based on the data in the map, which correspond to the detected fuel pressure, the microcomputer 12 sets the pulse width of an injection command signal so that a target injection quantity is achieved.

In order to promptly open each injector 6 from the closed state, the injector drive circuit 22 supplies an initial current as a drive current having a large peak current value to the electromagnetic driver of the injector 6. The initial current is supplied to the electromagnetic driver when the energy that has been charged to the capacitor of the step-up circuit is discharged in the injector drive circuit 22.

FIG. 2A is a time diagram illustrating a drive current under “control A” in the case where the pulse width of an injection command signal exceeds a predetermined width. In the case as shown in FIG. 2A, the injector drive circuit 22 cuts off the energy which is in the process of being discharged from the capacitor of the step-up circuit for use as the initial current. Then, the injector drive circuit 22 supplies a holding current as a drive current to each injector 6. The holding current has a current value smaller than the peak value of the initial current. In this way, an open state of each injector 6 is maintained in response to the pulse width of an injection command signal.

Once the injector 6 has been opened with the supply of the initial current, the current value of the holding current required for maintaining the open state may be smaller than the peak value of the initial current required for starting opening of the valve.

FIG. 2B is a time diagram illustrating a drive current under “control B” in the case where the pulse width of an injection command signal is equal to or less than the predetermined width. In the case as shown in FIG. 2B, a holding current is not supplied but an initial current alone is supplied to each injector 6.

Specifically, under control A described above, the injector 6 is closed by cutting off the supply of the holding current for the completion of a fuel injection. Under control B, the injector 6 is closed by cutting off the supply of the initial current for the completion of a fuel injection. These controls A and B are different from each other in the amount of the heat generated at the injector drive circuit 22.

It is known that the amount of heat generated at the injector drive circuit 22 becomes larger as the degree of lowering of the current value is larger in cutting off the supply of drive current, i.e. as the current value is larger before cutting off, the supply of drive current. Accordingly, the amount of heat generated at the injector drive circuit 22 by driving the injectors 6 is larger in the case of control B under which the supply of initial current is cut off to complete a fuel injection, than in the case of control A under which the supply of holding current is cut off to complete a fuel injection.

Thus, when the injector drive circuit 22 generates heat by the driving of the injectors 6, the temperature inside the ECU 10 will be raised. Each of the electronic parts including the microcomputer 12 in the ECU 10 is set with a temperature range (rated temperature) in which normal operation of the electronic part is guaranteed. Use of any of the electronic parts under a temperature exceeding the rated temperature may induce malfunction or failure.

(2) The Number of Injections

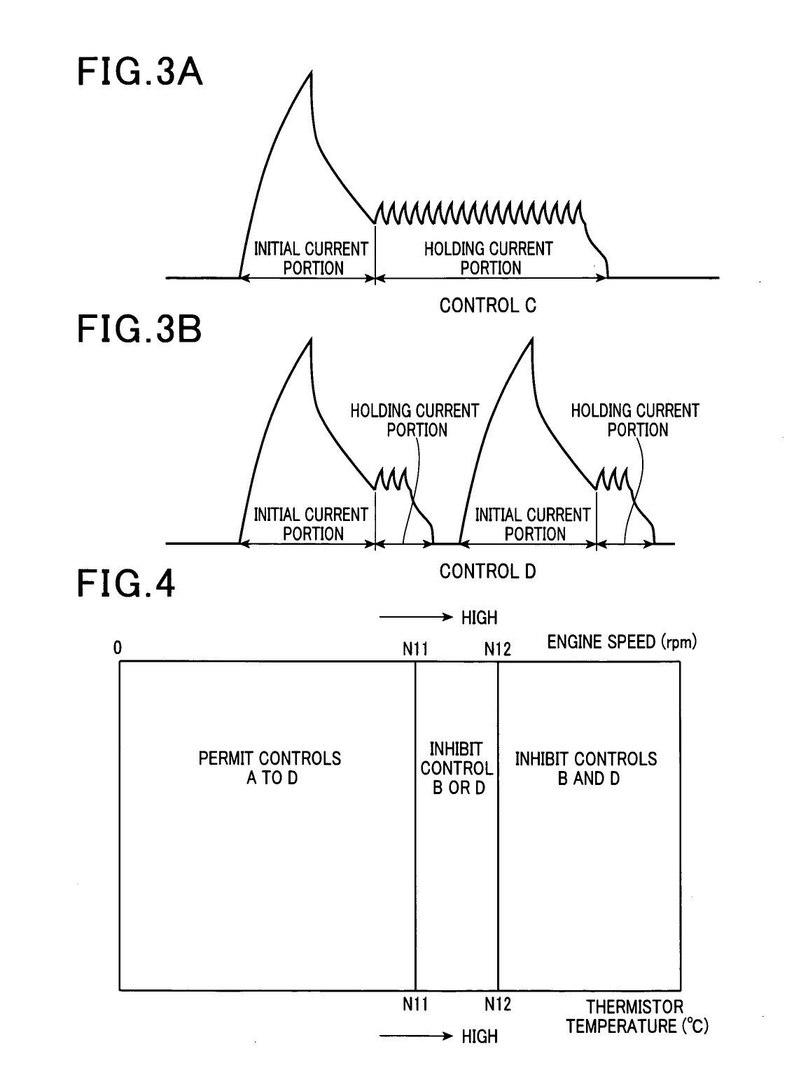

FIG. 3A is a time diagram illustrating single-stage injection for performing injection once under “control C”. FIG. 3B is a time diagram illustrating multi-stage injection for performing injection twice or more under “control D”.

In one combustion cycle in the case of a direct-injection engine, the single-stage injection under control C shown in FIG. 3A may be performed, or the multi-stage injection under control D shown in FIG. 3B may be performed in order to improve the mixed state of fuel and air before ignition. The pulse width of an injection command signal for each stage of the multi-stage injection under control D is set such that the total injection quantity of the multi-stage injection under control D will be equal to the injection quantity of the single-stage injection under control C.

The amount of heat generated at the injector drive circuit 22 by the driving of the injectors 6 is increased more as the number of injections in one combustion cycle is increased, i.e. as the number of times of driving the injectors 6 is increased. Accordingly, the amount of heat generated at the injector drive circuit 22 is increased more in the multi-stage injection than in the single-stage injection. When the injector drive circuit 22 generates heat by driving the injectors 6, the temperature inside the ECU 10 will be raised.

(Injection Control 1)

Hereinafter will be described “injection control 1” under which heat generation of the injector drive circuit 22 is reduced.

The ECU 10 obtains an output signal of the thermistor 30 disposed in the ECU 10 to detect the temperature inside the ECU 10 based on the output signal of the thermistor 30. Then, based on the detected temperature inside the ECU 10, the ECU 10 issues a command to execute injection control under which heat generation of the injector drive circuit 22 is reduced.

FIG. 4 is a characteristic diagram illustrating a relationship between thermistor temperature or engine speed and injection control. As shown in FIG. 4, for example, when the temperature inside the ECU 10 detected from the output signal of the thermistor 30 is not more than T11 that is a first temperature, the ECU 10 permits any of controls A to D shown in FIGS. 2A to 3B. When a detected temperature exceeds T11 but is not more than T12 that is a second temperature, the ECU 10 permits either one of controls B and D under which heat generation rate is large, and inhibits the other one of the controls. When a detected temperature exceeds T12, the ECU 10 inhibits both of controls B and D. It should be appreciated that the first and second temperatures T11 and T12 have a relation expressed by T11<T12.

As mentioned above, heat generation rate of the injector drive circuit 22 is raised as the number of injections is increased. Accordingly, as the engine speed becomes higher, the frequency of injection is increased to thereby raise heat generation rate of the injector drive circuit 22.

Thus, instead of directly detecting the temperature inside the ECU 10 from the output signal of the thermistor 30, the engine speed may be obtained as temperature information associated with the temperature inside the ECU 10, so that the temperature inside the ECU 10 can be estimated from the engine speed.

In this regard, as shown in FIG. 4, when the engine speed is not more than N11 that is a first engine speed, the ECU 10 permits any of controls A to D shown in FIGS. 2A to 3B. When the engine speed exceeds N11 but is not more than N12 that is a second engine speed, the ECU permits either one of controls B and D under which heat generation rate is large and inhibits the other one of the controls. When the engine speed exceeds N12, the ECU 10 inhibits both of controls B and D. It should be appreciated that the first and second engine speeds NT11 and N12 have a relation expressed by N11<N12.

In this way, temperature rise inside the ECU 10 is suppressed by performing injection control for decreasing heat generation of the injector drive circuit 22, based on the temperature inside the ECU 10 detected from the output signal of the thermistor 30 or based on the engine speed.

There may be a case where a target injection quantity is small and thus the fuel pressure of the moment may allow the pulse width of an injection command signal to be equal to or less than a predetermined width in order to achieve fuel injection of the target injection quantity. In such a case, control A with the pulse width exceeding the predetermined width may be permitted, while control B with the pulse width equal to or less than the predetermined width may be inhibited. In this situation of control, however, fuel injection for satisfying the target fuel injection quantity may not be performed.

In order to cope with this situation of control, the ECU 10 may reduce the discharge rate of the fuel pump 4 and reduce the pressure of fuel supplied to each injector 6 to achieve the target injection quantity, without changing injection quantity when control A is performed. Thus, in the case where a target injection quantity is small as well, fuel injection that will satisfy the target injection quantity can be performed under control A with the pulse width exceeding the predetermined width.

(Injection Control 2)

Hereinafter will be described another “injection control 2” under which heat generation of the injector drive circuit 22 is reduced.

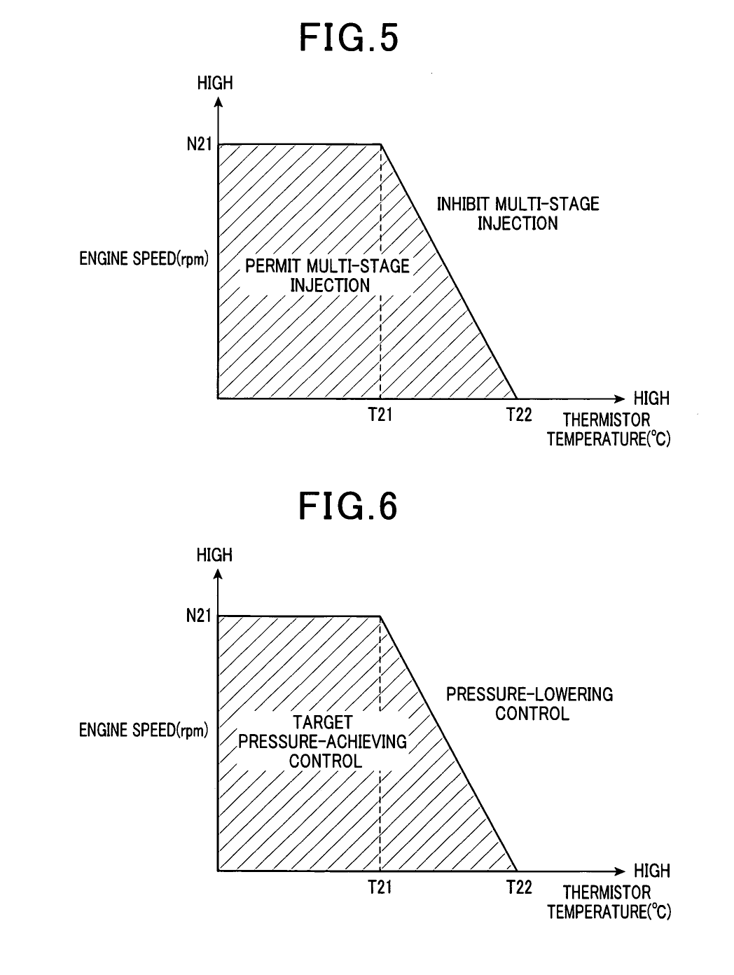

FIG. 5 is a characteristic diagram illustrating a relationship between thermistor temperature or engine speed and injection control. As shown in FIG. 5, when the temperature in the ECU 10 detected from the output signal of the thermistor 30 is not more than T21 that is the first temperature and the engine speed is not more than N21, the ECU 10 permits both of single-stage injection (control C) and multi-stage injection (control D). When the temperature in the ECU 10 detected from the output signal of the thermistor 30 is not more than T22 that is the second temperature and the engine speed is not more than N21, the ECU 10 permits single-state injection (control C) and multi-stage injection (control D) within the diagonally shaded area. It should be appreciated that a relation T21<T22 is established.

In the area of detected temperature and engine speed other than the above area, single-stage injection (control C) is permitted but multi-stage injection (control D) is inhibited.

Regarding controls A and B as well, the injection control for reducing heat generation of the injector drive circuit 22 may be performed, based on the temperature in the ECU 10 detected from the output signal of the thermistor 30 and the engine speed.

For example, when the temperature in the ECU 10 detected from the output signal of the thermistor 30 is not more than T21 and the engine speed is not more than N21, controls A and B may both be permitted. When the temperature in the ECU 10 detected from the output signal of the thermistor 30 is not more than T22 and the engine speed is not more than N21, controls A and B may be permitted in the diagonally shaded area.

In the area of detected temperature and engine speed other than the above area, control A may be permitted but control B may be inhibited.

(Injection Control 3)

Hereinafter is described another injection control 3 for reducing heat generation of the injector drive circuit 22.

The ECU 10 performs injection control 1 or injection control 2 for reducing heat generation of the injector drive circuit 22, based on the temperature in the ECU 10 detected from the output signal of the thermistor 30 and the engine speed. At the same time, the ECU 10 performs pressure control under which discharge rate of the fuel pump 4 is lowered to reduce the fuel pressure.

FIG. 6 is a characteristic diagram illustrating a relationship between thermistor temperature or engine speed and fuel pressure. As shown in FIG. 6, for example, when the temperature in the ECU 10 detected from the output signal of the thermistor 30 is not more than T21 and the engine speed is not more than N21, the ECU 10 controls discharge rate of the fuel pump 4 so as to achieve a target pressure which is based on the engine operating conditions.

When the temperature in the ECU 10 detected from the output signal of the thermistor 30 is not more than T22 and the engine speed is not more than N21, the ECU 10 controls discharge rate of the fuel pump 4, in the diagonally shaded area, so as to achieve a target pressure which is based on the engine operating conditions.

In the area of detected temperature and engine speed other than the above area, discharge rate of the fuel pump 4 is lowered to a level less than the discharge rate which is in conformity with a target pressure, thereby reducing the pressure of fuel supplied to each injector 6. When fuel pressure is lowered, heat generation rate of the injector drive circuit 22 is lowered.

As a matter of course, in the case where fuel pressure is reduced while injection control 1 or 2 is performed, it is desirable that reference is made to the injection characteristics map for the data suitable for the fuel pressure and that the pulse width of the injection command signal is set so as to achieve a target injection quantity.

In the embodiment described so far, the output signal of the thermistor 30 and the engine speed have been used as temperature information associated with the temperature in the ECU 10. Then, any of controls 1, 2 and 3 has been performed when the value of at least one of the output signal and the engine speed exceeds a predetermined value and falls in a range that requires injection control for reducing heat generation of the injector drive circuit 22.

Thus, since temperature rise is suppressed in the ECU 10, the electronic parts in the ECU 10 are each able to operate at a rated temperature. As a result, the electronic parts in the ECU 10 are prevented from encountering malfunction and failure.

Also, since heat generation of the injector drive circuit 22, per se, is reduced, temperature rise in the ECU 10 is suppressed without the necessity of additionally providing a cooling mechanism.

It should be appreciated that the ECU 10 of the present embodiment corresponds to the fuel injection control apparatus, the injector drive circuit 22 of the present embodiment corresponds to the drive circuit, and the thermistor 30 of the present embodiment corresponds to the temperature sensor. Also, the ECU 10 functions as the injection control means, the temperature information obtaining means and the pressure control means.

(Modifications)

The present invention is not limited to the embodiment described above but may be applied to various embodiments within a scope not departing from the spirit of the present invention.

For example, in the embodiment described above, at least one or more fuel injections have been performed in one combustion cycle in each of the cylinders of the engine. Alternative to this, a combustion cycle in which fuel is not injected may be provided by inhibiting fuel injections in the combustion cycle, in the event a value included in the temperature information falls in the range that requires fuel control for reducing heat generation of the injector drive circuit 22.

In the embodiment described above, the configuration of the embodiment has been applied to a direct-injection gasoline engine. However, other than this, the configuration of the embodiment may be applied to a diesel engine that is a cylinder-injection internal combustion engine.

In the above embodiment, the functions of the injection control means, the temperature information obtaining means and the pressure control means have been realized by the ECU 10 in which the functions are defined by a control program. Alternative to this, at least a part of the functions of the plurality of means may be realized by hardware in which the functions are defined by the circuit configuration, per se.

Hereinafter, aspects of the above-described embodiments will be summarized.

As an aspect of the embodiment, a fuel injection control apparatus, which is applied to a cylinder-injection internal combustion engine directly injecting fuel into a cylinder from a fuel injection valve, includes: an injection control unit which issues a command to perform injection control for the fuel injection valve by using an injection command signal; a drive circuit which drives the fuel injection valve based on the injection command signal outputted from the injection control unit; and a temperature information obtaining unit which obtains temperature information associated with temperature in the fuel injection control apparatus. The injection control unit issues a command to perform injection control for reducing heat generation of the drive circuit by using the injection command signal based on the temperature information obtained by the temperature information obtaining unit.

Thus, a command is issued to perform injection control to reduce heat generation of the drive circuit, which would cause temperature rise in the fuel injection control apparatus. With the issuance of the command, temperature rise in the fuel injection control apparatus is suppressed without the necessity of additionally providing a cooling mechanism for cooling the apparatus from outside.

The fuel injection control apparatus further includes a temperature sensor which detects a temperature inside the fuel injection control apparatus. The temperature information obtaining unit obtains an output signal of the temperature sensor as the temperature information. Thus, the temperature in the apparatus is correctly detected, enabling issuance of a command for performing appropriate injection control.

The increase of engine speed will necessitate the drive circuit to increase the frequency of driving fuel injection valves. Therefore, the temperature in the apparatus is likely to be increased.

In this regard, the temperature information obtaining unit obtains engine speed as the temperature information.

Thus, the temperature in the apparatus is estimated by obtaining the engine speed as temperature information associated with the temperature in the apparatus. Meanwhile, a command is issued to perform the injection control for reducing heat generation of the drive circuit based on the engine speed, thereby suppressing temperature rise in the apparatus.

Since engine speed is used for normal engine control, engine speed can be obtained as temperature information without additionally providing a sensor for sensing engine speed.

In the fuel injection control apparatus, when the signal width of the injection command signal is not more than a predetermined width, the drive circuit drives the fuel injection valve by using an initial current which is supplied to the fuel injection valve to open the fuel injection valve, and when the signal width of the injection command signal exceeds the predetermined width, the drive circuit drives the fuel injection valve by using a holding current having a current value smaller than the peak value of the initial current to maintain the open state of the fuel injection valve after being opened by the initial current.

Thus, in starting opening of each fuel injection valve, it is necessary to drive the fuel injection valve with a current having a peak value which is larger than a current for maintaining the open state of the valve after being opened. When the signal width of an injection command signal is not more than the predetermined width, each fuel injection valve is opened with the initial current and closed with the cutoff of the initial current. On the other hand, when the signal width of an injection command signal exceeds the predetermined width, each fuel injection valve is opened with the initial current and closed with the cutoff of the holding current having a current value smaller than the peak value of the initial current.

The amount of heat generated by the drive circuit when the initial current is cut off is larger than the heat generated when the holding current is cut off, which has a current value smaller than the peak value of the initial current.

In the fuel injection control apparatus, when a value of the temperature information falls in a range that requires injection control for reducing heat generation of the drive circuit, the injection control unit sets the signal width of the injection command signal so as to exceed the predetermined width.

Thus, each fuel injection valve is closed by cutting off the holding current having a current value smaller than the initial current. Therefore, the amount of heat generated by the drive circuit will be more reduced than in the case of closing the fuel injection valve by cutting off the initial current. As a result, heat generation of the drive circuit is reduced and thus temperature rise in the apparatus is suppressed.

In the fuel injection control apparatus, when a value of the temperature information falls in a range that requires injection control for reducing heat generation of the drive circuit, the injection control unit does not issue a command to perform multi-stage injection in one combustion cycle and issues a command to perform single-stage injection in the one combustion cycle.

Thus, by reducing the number of times of injections in one combustion cycle, temperature rise in the apparatus is suppressed.

In the fuel injection control apparatus, when a value of the temperature information falls in a range that requires injection control so for reducing heat generation of the drive circuit, the injection control unit issues a command to perform injection control for reducing heat generation of the drive circuit without changing injection quantity of the fuel injection valve. Thus, fuel equivalent to a target injection quantity is injected from each fuel injection valve, while heat generation of the drive circuit is reduced.

When the pressure of fuel supplied to each fuel injection valve is increased, the amount of heat is likely to be increased which would be generated by the drive circuit when the fuel injection valve is driven.

In this regard, the fuel injection control apparatus includes a pressure control unit which controls pressure of fuel supplied to the fuel injection valve. When a value of the temperature information falls in a range that requires injection control for reducing heat generation of the drive circuit, the pressure control unit reduces the pressure. Thus, the amount of heat generated by the drive circuit is reduced and thus temperature rise in the apparatus is suppressed.

The functions of the plurality of means provided in the embodiment are realized by hardware resources in which the functions are defined by the configuration, per se, or by hardware resources in which the functions are defined by a program, or by combination of these hardware resources. The functions of the plurality of means are not limited to the ones realized by hardware resources which are physically independent of each other.

What is claimed is:

1. A fuel injection control apparatus, which is applied to a cylinder-injection internal combustion engine directly injecting fuel into a cylinder from a fuel injection valve, comprising:
an injection control unit which issues a command to perform injection control for the fuel injection valve by using an injection command signal;
a drive circuit which drives the fuel injection valve based on the injection command signal outputted from the injection control unit; and
a temperature information obtaining unit which obtains temperature information associated with temperature in the fuel injection control apparatus, wherein
the injection control unit issues a command to perform injection control for reducing heat generation of the drive circuit by using the injection command signal based on the temperature information obtained by the temperature information obtaining unit.

2. The fuel injection control apparatus according to claim 1, further comprising a temperature sensor which detects a temperature inside the fuel injection control apparatus, wherein
the temperature information obtaining unit obtains an output signal of the temperature sensor as the temperature information.

3. The fuel injection control apparatus according to claim 1, wherein the temperature information obtaining unit obtains engine speed as the temperature information.

4. The fuel injection control apparatus according to claim 1, wherein
when the signal width of the injection command signal is not more than a predetermined width, the drive circuit drives the fuel injection valve by using an initial current which is supplied to the fuel injection valve to open the fuel injection valve,
when the signal width of the injection command signal exceeds the predetermined width, the drive circuit drives the fuel injection valve by using a holding current having a current value smaller than the peak value of the initial current to maintain the open state of the fuel injection valve after being opened by the initial current, and
when a value of the temperature information falls in a range that requires injection control for reducing heat generation of the drive circuit, the injection control unit sets the signal width of the injection command signal so as to exceed the predetermined width.

5. The fuel injection control apparatus according to claim 1, wherein
when a value of the temperature information falls in a range that requires injection control for reducing heat generation of the drive circuit, the injection control unit does not issue a command to perform multi-stage injection in one combustion cycle and issues a command to perform single-stage injection in the one combustion cycle.

6. The fuel injection control apparatus according to claim 1, wherein
when a value of the temperature information falls in a range that requires injection control for reducing heat generation of the drive circuit, the injection control unit issues a command to perform injection control for reducing heat generation of the drive circuit without changing injection quantity of the fuel injection valve.

7. The fuel injection control apparatus according to claim 1, further comprising a pressure control unit which controls pressure of fuel supplied to the fuel injection valve, wherein
when a value of the temperature information falls in a range that requires injection control for reducing heat generation of the drive circuit, the pressure control unit reduces the pressure.
